(19) United States
(12) Patent Application Publication
(10) Pub. No.: US 2017/0354100 A1
(43) Pub. Date: Dec. 14, 2017

(54) Safety Grow Pod

(71) Applicant: Jason Snyder, Santa Rosa, CA (US)

(72) Inventor: Jason Snyder, Santa Rosa, CA (US)

(21) Appl. No.: 15/620,778

(22) Filed: Jun. 12, 2017

Related U.S. Application Data
(60) Provisional application No. 62/348,778, filed on Jun. 10, 2016.

(51) Int. Cl. A01G 9/24; A01G 1/00

(52) U.S. Cl. CPC A01G 9/247; A01G 9/246; A01G 9/241; A01G 1/001

(57) ABSTRACT

A grow pod comprises a container having a sprinkler system, a water reclamation system, a climate control system, a control system, a security system and a plant drying system; and a method of water reclamation for subsequent use within the grow pod.

### BACKGROUND

The present invention relates to a self-contained growing pod for use within commercial and residential structures. The invention more particularly relates to growing pods having unique safety and water reclamation features.

Grow pods are artificially controllable environments for growing plants. Grow pods have been known to contain a variety of electrical components. The purpose of a grow pod is to cultivate plants, which need water. The combination of the electronic components, heat generated from the electronic components and water create a substantial risk for fires.

All of the water necessary for plant growth must be supplied to the grow pod. Grey water is created from several sources the HVAC and Dehumidification systems produce grey water that is relatively pure. The grey water produced from the run off from watering the plants contains waste from the plants in the form of salts and extra nutrients that the plants did not absorb. The grey water is often drained to waste creating high water and sewer costs.

### SUMMARY

A safety grow pod embodying the principles of the present invention comprises a container having vertical sidewalls, a top wall and a base which define a growing or drying chamber. The container may safely be used inside other structures because of its fire safety features including a sprinkler system have a sprinkler head coupled to a water supply line; a sensor mounted within the container that communicates directly with an output devise to activate or deactivate liquid flow to the supply line and sprinkler head, as a further benefit the data from the sensor may be sent to a remote user.

The container's climate is optimized for plant growth by climate control system which distributes air of a specific temperature to the interior of the container, and removes air from the container, the system has at least one supply and one return for this purpose. The climate control system is managed by a control system with sensors, controllers, output devices, and user interfaces. It can be monitored and controlled remotely. The climate control system further controls the climate with a dehumidifier integrated within the system.

A safety grow pod includes a reclamation system having reservoirs and pumps for reusing grey water, the water reclamation system has a control system with sensors; a controller; an output device; and a user interface. The sensors and pumps are located within each of the reservoir for communicating measurements of a liquid such as PH, PPM to the controller. The controller processes communications from the sensor relaying information to output device for activating or deactivating the pumps. The effect is that the plant runoff liquid may be reused in combination with the greywater from the climate control system in the feeding reservoir for reuse as plant food and water. The control system effectuates the transfer of liquid between the reservoirs via the pump according to parameters set by the operator.

In some embodiments, the sidewall and the top wall are double-walled insulated panels with metal panels sandwiching insulation material having a flame spread of less than 25. The frame supporting the walls is made of a material having a flame spread of less than 25. These materials increase the fire safety of the pod.

In some embodiments, the safety grow pod has a security system which includes a door that is operated and locked electronically so that access can be controlled and monitored. A security camera may be located exterior or interior to the grow pod and integrated within the control system for remote monitoring of the grow pod.

In some embodiments, the safety grow pod may be used for drying and curing plants. This is accomplished by using the container's climate control system with the addition of a humidifier to optimize temperature and humidity according to the product requirements. In addition, the plants are mounted to a conveyor with a track and plant mount for easy of mounting an removing plants.

### BRIEF DESCRIPTION OF THE DRAWINGS

FIG. 1A 2-D cross-section view of an embodiment of a safety grow pod.

FIG. 2A front view of an embodiment of a safety grow pod highlighting an embodiment of the exterior portion of the climate control system.

FIG. 3 An isometric view of an embodiment of the exterior of the safety grow pod.

FIG. 4 A diagram illustrating the grey water reclamation system of the safety grow pod.

FIG. 5 An isometric view illustrating a version of the safety grow pod frame.

FIG. 6 An isometric view illustrating components the plant drying system.

FIG. 7 An isometric view of an embodiment of the plant drying system, one or more side walls are not shown for illustrative purposes.

FIG. 8 A top view of a version of a plant drying conveyor.

FIG. 9 A front partial view of the interior of the safety pod configured with a two-room plant drying system.

FIG. 10 An isometric view of the safety grow pod illustrating the security system.

### DETAILED DESCRIPTION

The invention as illustrated is a self contained module for growing plants, conveniently named a grow pod. The grow pod is comprised of a series of systems that allow for safe and efficient growing of plants in a secondary structure, such as a house, garage, barn or other structure allowing for the housing of the grow pod.

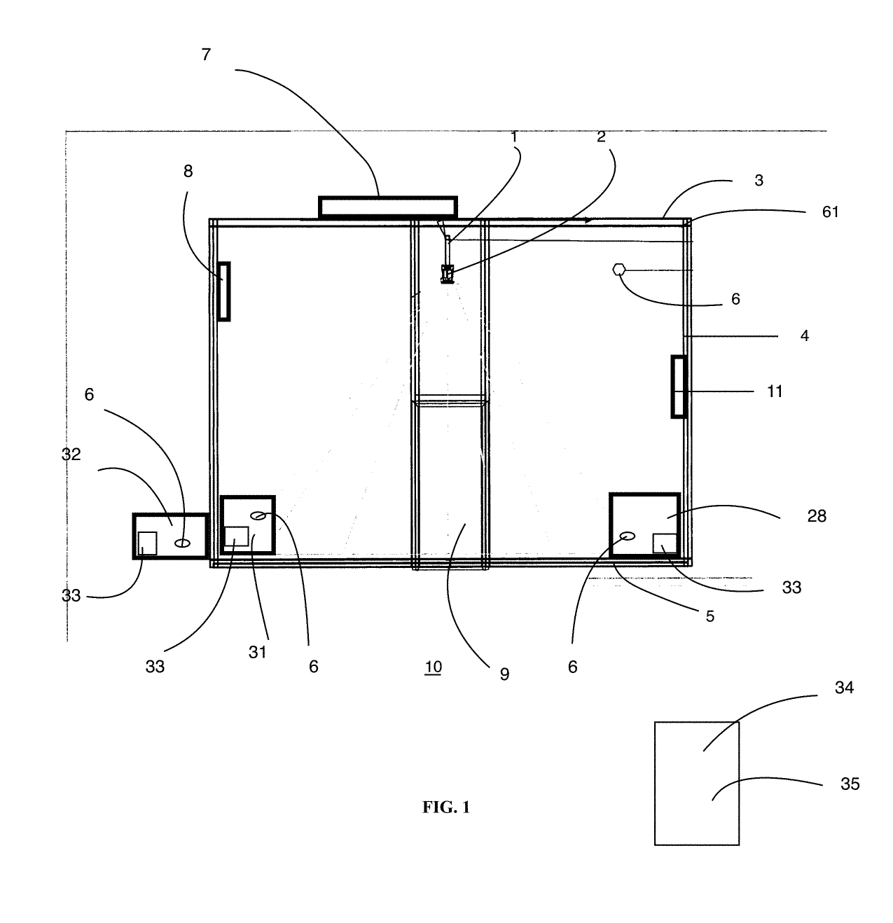

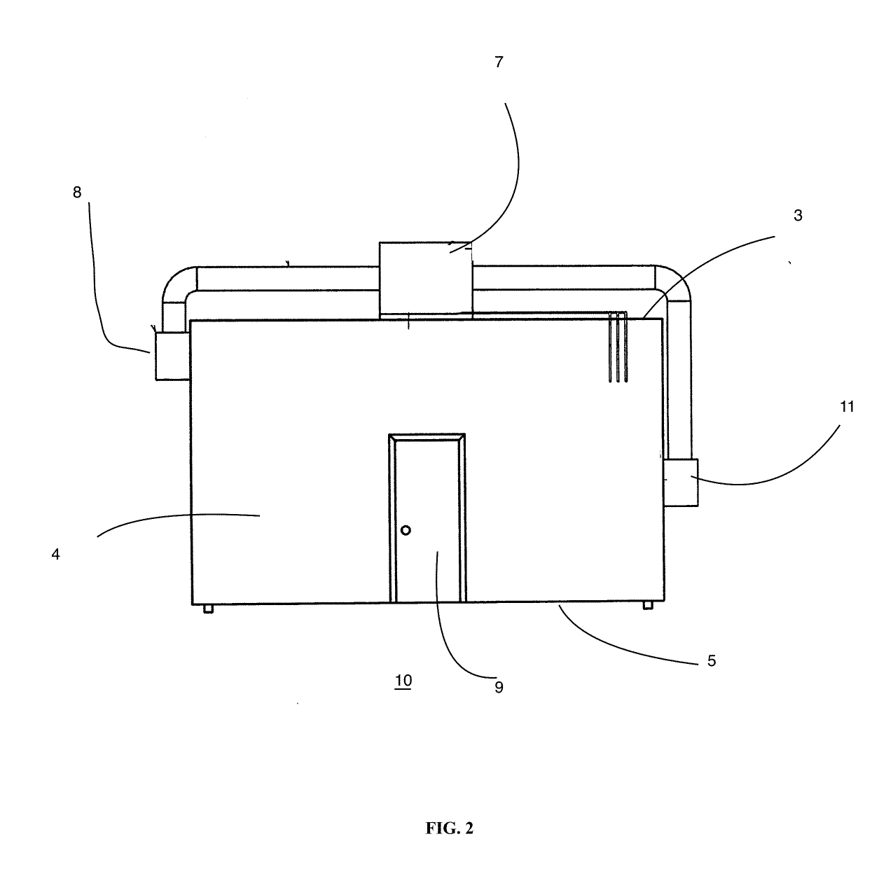

FIGS. 1-3 depict a safety grow pod in accordance with the invention, for safely growing plants in a container 10, comprising at least one substantially vertical side wall 4, a top wall 3 and a base 5. The sidewalls 4, the top wall 3 and base 5 are constructed of material that has a flame spread rating of less than 25 and a smoke spread rating of less than 450. In a preferred embodiment, the sidewall 4, the top wall 3 and base 5 are constructed of insulation with paneling on either side creating a double wall with insulation inbetween. In one embodiment, the double wall consists of a 26, 24, or 22-inch Galvanized Steel Inverted Rib Aluminum Zinc pre-painted steel panels and the insulation core of the panels consists of mineral and wool. The walls and base have a high r value ranging from 31-49, stabilizing the temperature within the container and saving on energy costs. The container 10 has a door 9 for access into the container 10. The container 10 has dimensions within the following range 6′-60′×6′-60′×8′-18′ (length×width×height). The dimensions are measured in feet. The container 10 is configurable and scalable. The preferred dimensions of the container are 6×6×12; 20×20×12; and 40×40×12.

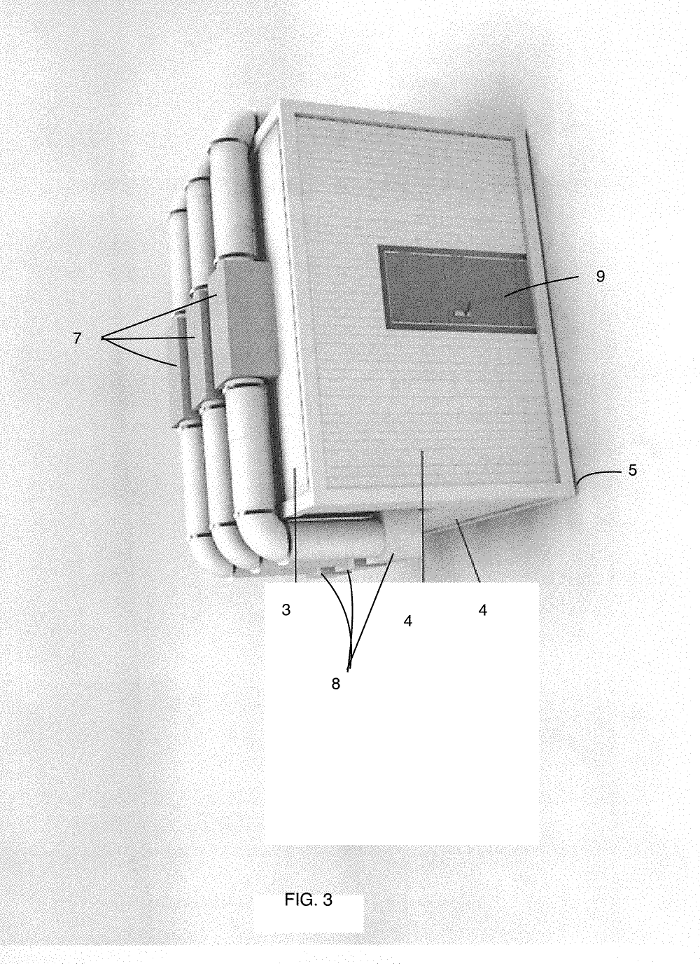

As depicted in FIG. 5, the frame 15 is built according to building code. In a preferred embodiment, the frame is constructed of material that has a flame spread rating of less than 25. The container 10 is constructed by building the frame 15 as the structural support for the container 10 a door. The sidewalls 4, the top wall 3 and base 5 are assembled around the the frame. As shown in FIG. 3, the sidewalls 4, the top wall 3 and base 5 are modular tongue and groove cold storage panels with the above specified r-values and fire rating.

As shown in FIG. 1, the safety grow pod comprises a sprinkler system. The container 10 has port to accommodate a sprinkler supply line 1. The supply line 1 ranges in size from 0.5 inches to 3 inches. In the preferred embodiment, the supply line 1 is one-inch. The water supply line 1 is attached to a fire sprinkler head 2 at one end, the other end is attached to a water supply. The water supply line 1 varies in size based on the size of the system and the pressure of available water. The opening with the supply line 1 is sealed to prevent air, light or gas to substantially pass through the opening. The container 10 may have more than one sprinkler head 2. The number of sprinkler heads 2 will be calculated and determined based on the size of the container 10. A sensor 6 is mounted within the container for detecting smoke and/or carbon monoxide. The sensor 6 is integrated within a control system additionally comprising a controller 35; an output device [maybe integrated within a pump 33, or the hot and cold distribution unit 7]; and a user interface 34. The controller 35 and the user interface 34 are utilized across all systems for setting and implementing the parameters within the container 10. When the sprinkler system is integrated with the control system, alerts may be sent to an operator in a remote location. In response, the user is able to activate various systems within the container 10, to mediate potential damage from a fire, such as shut off air supply and ensure the sprinkler system is activated. In a preferred embodiment, the sensor 6 communicates to a controller 35 (such as a computer processor) via Bluetooth, hardwire, or wifi, the controller 35 in accordance with preset parameters activates or deactivates liquid flow to the supply line 1 and sprinkler head 2.

The climate control system though integrated with the control system, which comprises a controller 35, an output device [maybe integrated within a pump 33, or the hot and cold distribution unit 7], a user interface 34 and a sensor 6, is different in that the climate control system, which also contains at least one supply 11 and at least one return 8 defined in the container, a hot and cold distribution unit 7 mounted to the exterior of the container and a dehumidifier 26. As shown in FIGS. 1 & 2, the hot and cold distribution unit 7, such as a variable Refrigerant Flow (VRF) unit is mounted to the top wall 3. The hot and cold distribution unit 7 is plummed to the supply 11 and return 8 with, for example, 4-18-inch PVC pipe. In the preferred embodiment, the supply 11 is integrated into lower portion of the sidewall 4 for supplying air into the container 10. The return 8 integrated into the upper portion of the sidewall 4, on the opposite sidewall 4. The return 8 removes air from the container 10.

At least one climate sensor 6, for example, a HVAC automated control sensor is mounted within the container 10. The sensor 6 is integrated within the control system. The control system comprising a controller 35; an output device [maybe integrated within the hot and cold distribution unit 7]; and a user interface 34. The sensor 6 communicates to a controller 35 (such as a computer processor) via Bluetooth, hardwire, or wifi, the controller 35 in accordance with preset parameters activating or deactivating the hot and cold distribution unit 7. The climate control system is light and efficient and mounted to the container 7 requiring only a power supply.

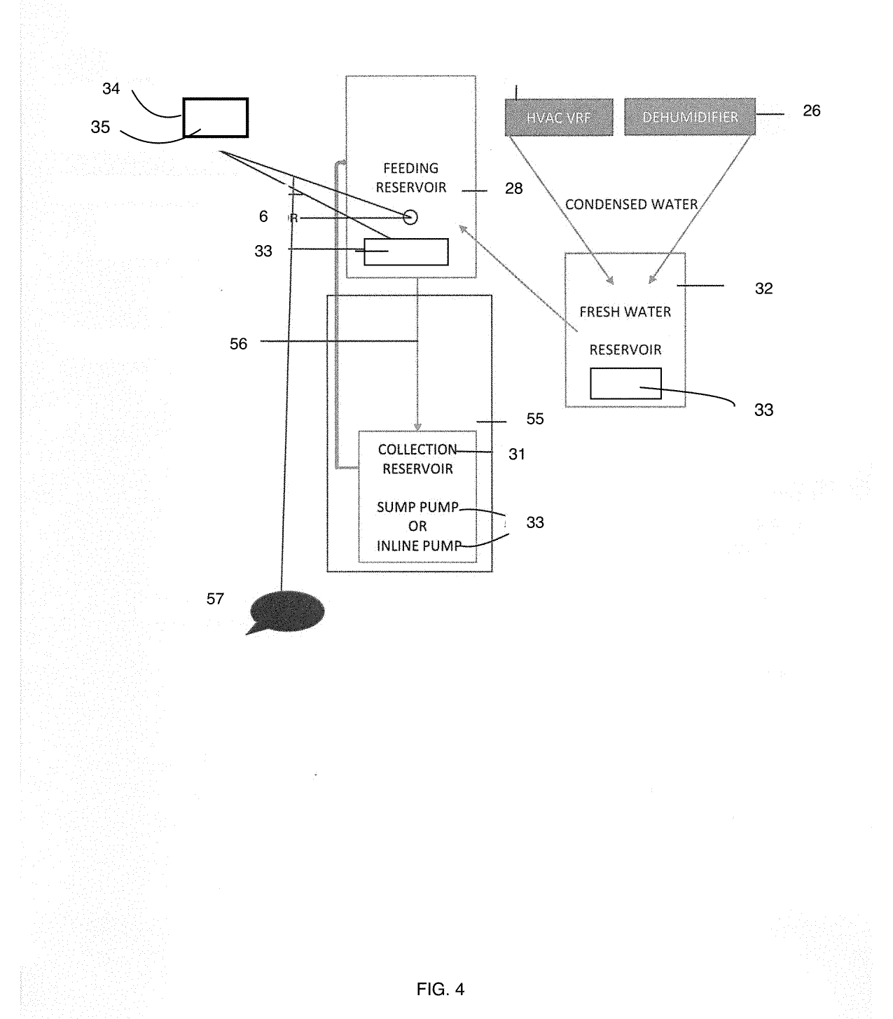

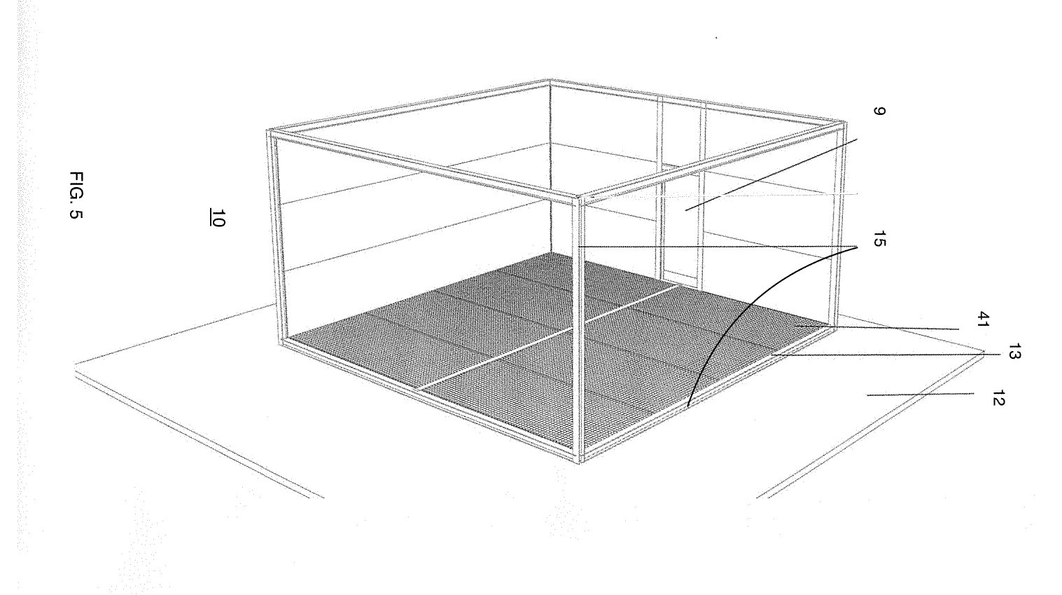

As depicted in FIG. 1 and illustrated in FIG. 4, the safety grow pod comprises a grey water reclamation system including at least a feeding reservoir 28 and a collection reservoir 31. The reclamation system may also include a fresh water reservoir 32 which receives condensed water from the hot and cold distribution unit 7 and the dehumidifier 26. The feeding reservoir 28 is initially filled with water from an outside source, the water is then pumped to water potted plants or a hydroponic system. Nutrients, PH adjusters or other additives are added to the water in the feeding reservoir 28 for feeding cycles. The parts per million (“PPM”) or mass per volume of chemicals in solution and PH measurements are critical when feeding plants. The runoff from watering or feeding the plants is captured in a collection reservoir 31. This water is available for reuse and may be pumped into the feeding reservoir 28 so long as the PPMs and the PH are within is a range required by the plants. The fresh water reservoir 32 is pumped into the feeding reservoir 28 to lower the PPM of the runoff water. Water from an outside source may be used to fill or dilute the feeding reservoir 28 if the fresh water reservoir 32 isn't available.

Sensors 6, such as PH meters and PPM meters, and pumps 33 are disposed within each of the reservoirs 31, 28, & 32. The sensors 6 communicate measurements to the controller 35, the controller 35 processes communications from the sensors 6 according to preset parameters for controlling the pumps 33. The pumps effectuate the transfer of liquid between the reservoirs 32, 28, & 31 via the pumps 33; the user interface 34 receives parameters from an operator and displays output from the controller. The whole process could be accessed via Bluetooth or WiFi on a hand held device 57, such as a smart phone or tablet. During the week the PH in the Feeding Reservoir 28 will either rise or fall depending on the plants life cycle and to some extent the plant nutrients used in the Feeding Reservoir 28. Using an automatic PH adjustor located within the Feeding Reservoir 28 in conjunction with the control system, an operator or the controller may request the PH adjuster make adjustments before sending out water to the plants.

The pumps 33 are plummed between reservoirs 32, 28, & 31, with, e.g., PVC pipe. The water collect into the collection reservoir 31 and fresh water reservoir is gravity collected. However, the water may be pumped if necessary.

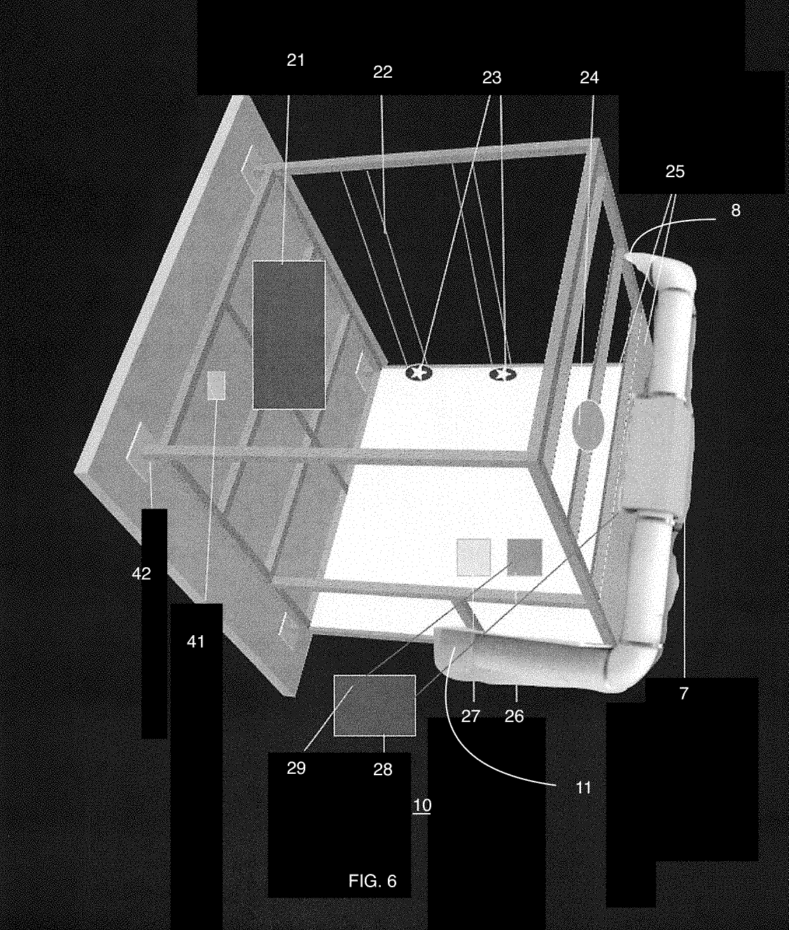

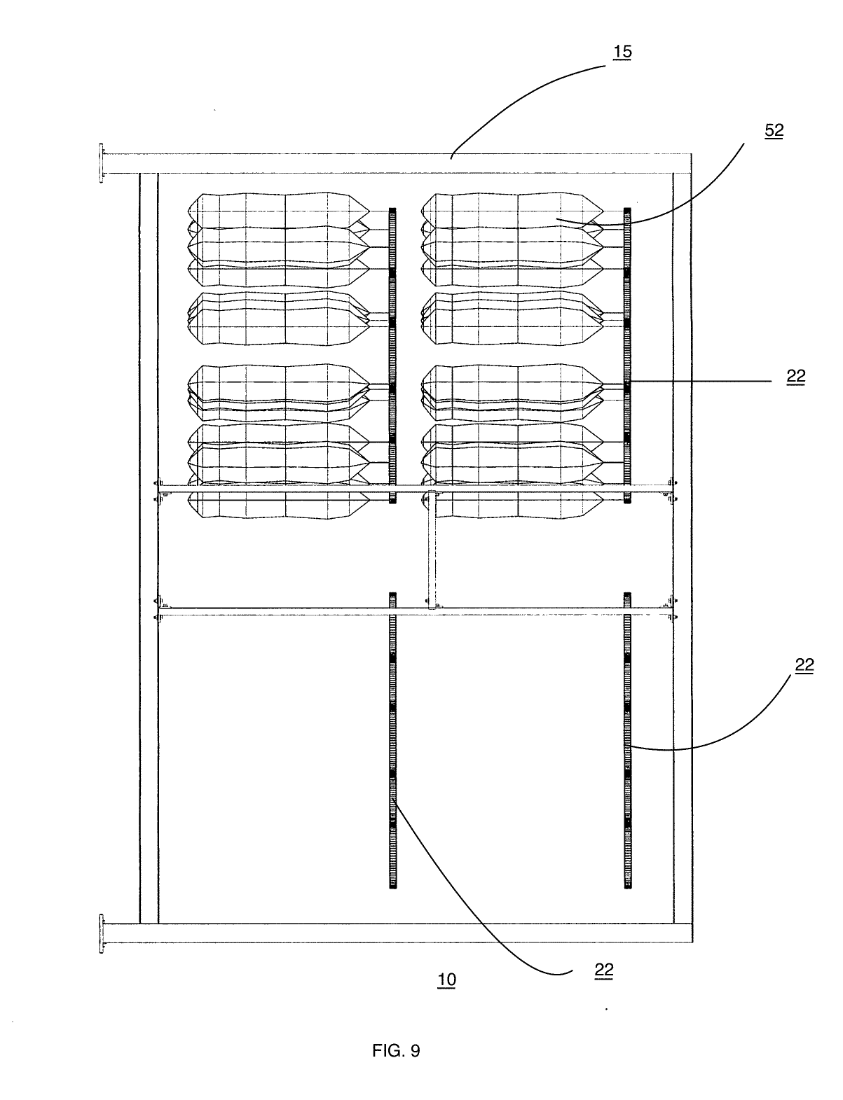

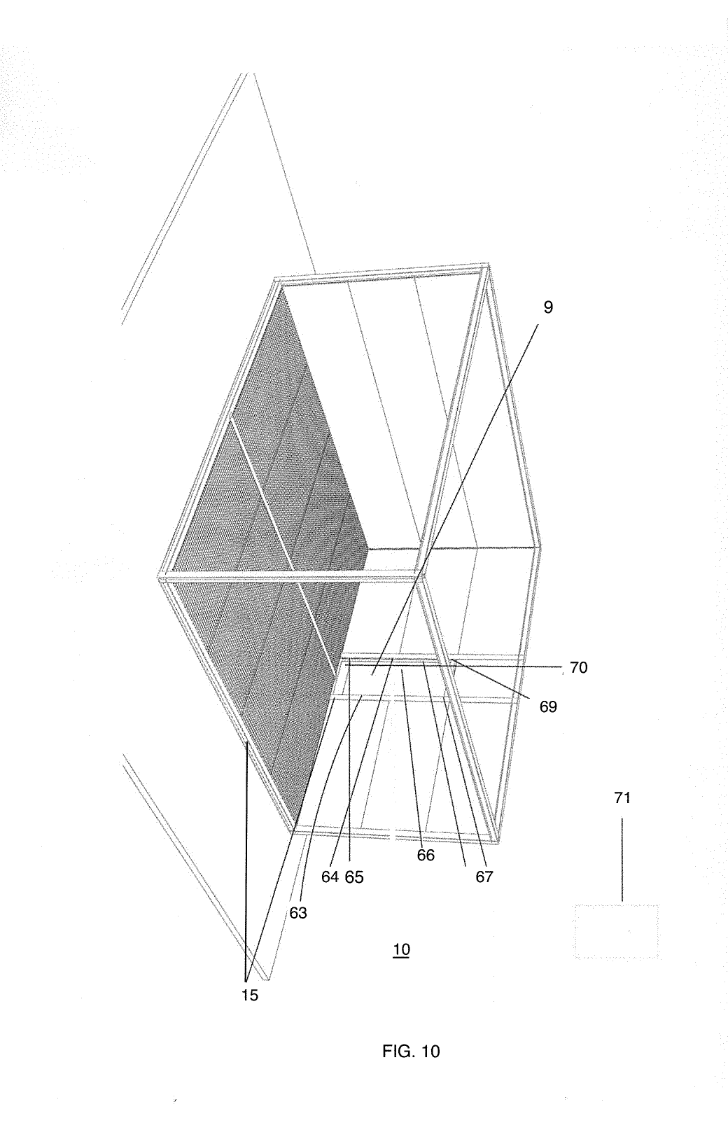

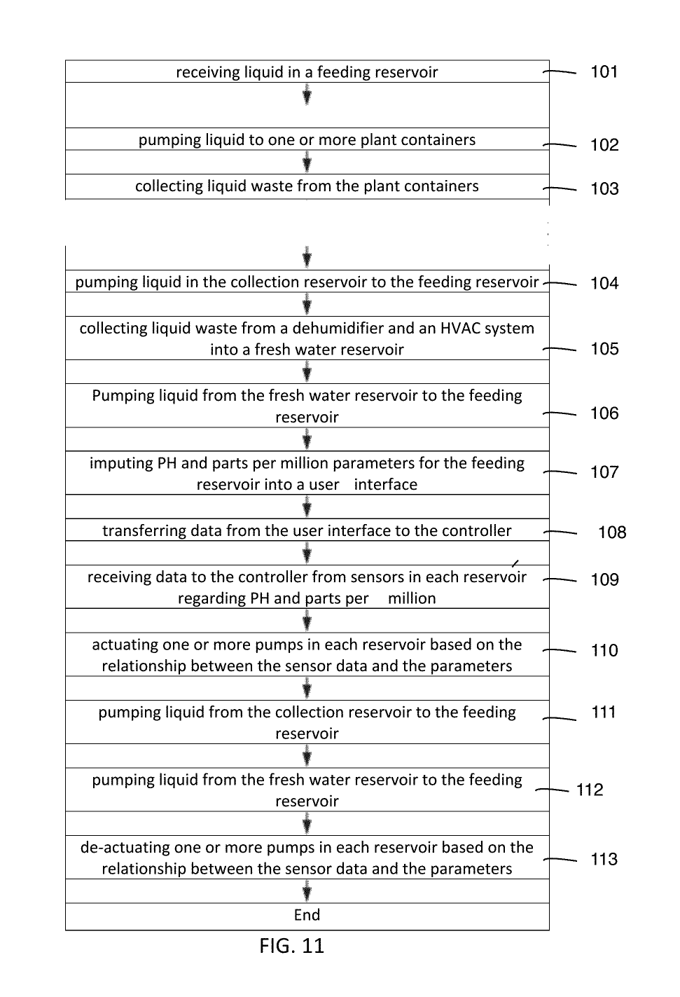

As shown in FIGS. 6-9, the safety grow pod further comprises a plant drying system having at least one conveyor 22 with a track and plant mount, the conveyor system is mounted substantially perpendicular the sidewalls 4 and parallel to the top wall 3 wherein pants are mounted to the conveyor system for drying. The plant drying system further comprises a humidifier 27 for increasing the moisture content of the container 10 according to parameters entered into the controller.

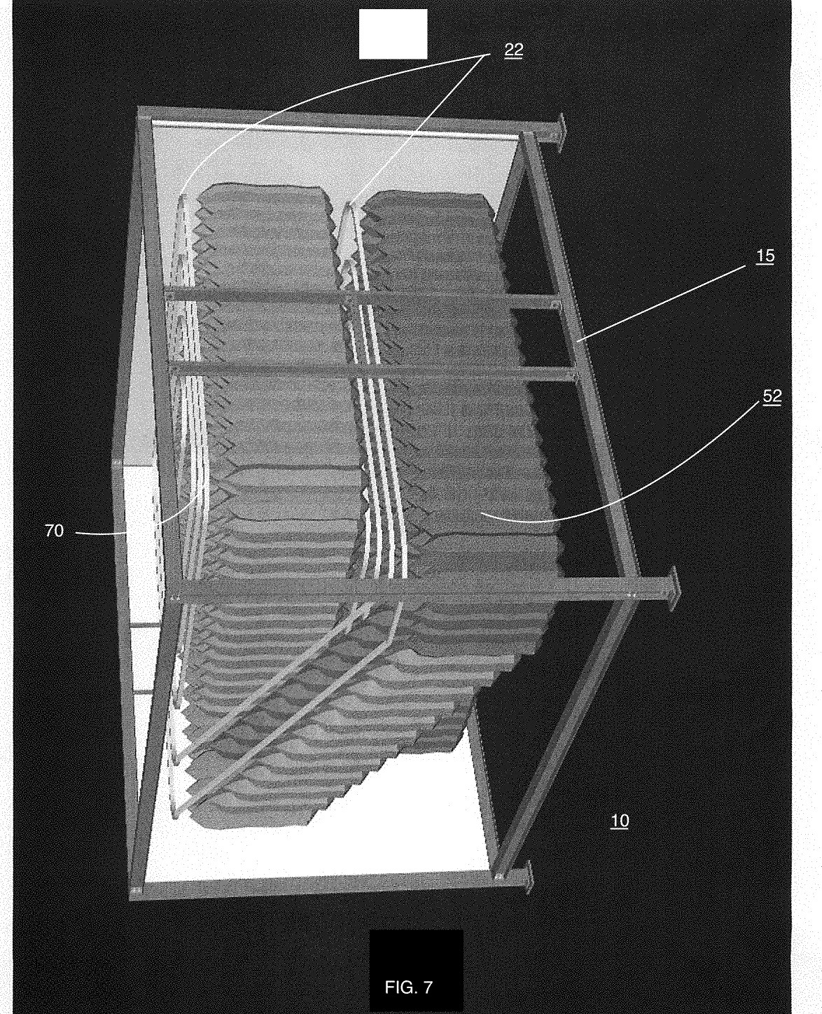

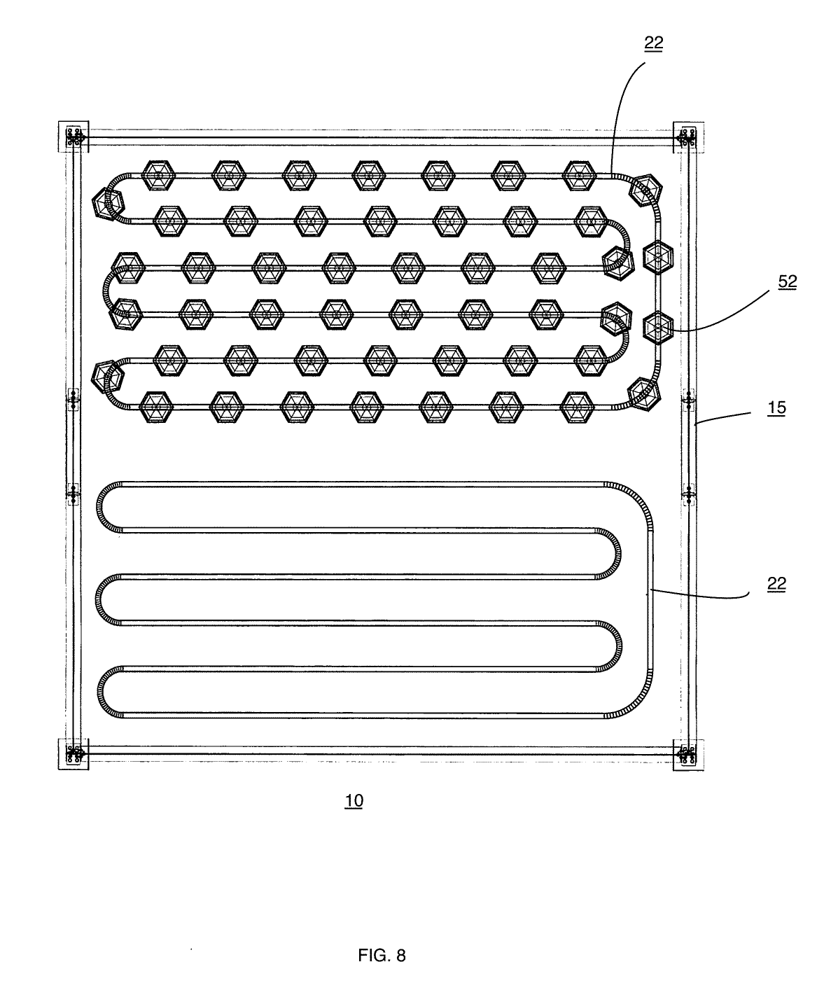

The plant drying system integrates into the grow pod. The grow pod may be modified subsequent to the growing cycle into drying and curing pod. In the alternative, an operator may have two pods one configured for growing and one configured for curing. As shown in FIG. 6, the container 10 is configured for drying and curing the plants. The container 10 has the climate control system 7, 26, 27, 11, & 8. If further comprises, the conveyor 22 (as shown in FIGS. 7-9), plant mounts 70 for hanging the plants for drying and curing. The mounts may be wire. Wire mounts are illustrated independent of the conveyor in FIG. 8 as 22.

The plant drying system may further comprise a base 5 having an interior layer of CDX plywood (painted with epoxy paint) base 21; one or more base grates 41; an elevated base 42 that is 2-8 inches off the subbase 12 wherein the base provides extra structural integrity

The grow or curing pod further comprises a security system comprising a door 9 having electronic hinges 67 mounted to the frame 15, an electric lock set integrated within the door; an electric key reader 64 communicates with the electric lock set 66; and an electronic key 71. The security system may further comprise a security camera 24 (as shown in FIG. 6). The security system in also integrated into the control system, such that it can be operated and monitored remotely. The control system is the same system used and discussed throughout.

### A Method of Operating a Grow Pod Water Reclamation System

A method of operating a grow pod water reclamation system starts with adding water or nutrient solution (“the receiving liquid”) to the feeding reservoir 101. The liquid (water or nutrient mix) is then pumped to one or more plant containers or hydroponic reservoir 102. The runoff grey water from the plant containers or hydroponic reservoir is captured in a collection reservoir 103. The runoff grey water/liquid collected in the collection reservoir is pumped to the feeding reservoir 104 for reuse if specified by the parameters set by the user. The runoff can only be used if the PPM and the PH are within an adjustable range. The method may further comprise of collecting liquid waste from a dehumidifier and an HVAC system into a fresh water reservoir 105. This water may be used to dilute the PPMS or modify the PH in the feeding reservoir. lithe water is needed in the feeding reservoir, it is pumped from the fresh water reservoir into the feeding reservoir in a specified volume 106. The method may further comprise an operator imputing PH and PPM parameters for the feeding reservoir into a user interface 107. The parameter data is transferred to a controller, such as a computer, then processed and store 108. The controller also receives data from sensors in each reservoir regarding PH and PPM 109. All of the data is processed according to the input parameters. The controller, according to the parameters activates one or more pumps, either pumping water from the fresh water reservoir to the feeding reservoir or pumping water from the collection reservoir to the feeding reservoir, or activating both pumps at once 110-112. The controller also deactivates the pumps according to the parameters 113.

1. A safety grow pod comprising:
A container having at least one substantially vertical sidewall, a top wall and a base, the top wall and base intersecting the at least one substantially vertical sidewall, wherein the vertical sidewall, top wall and base define a growing area, the side wall, the top wall and the base are supported by a frame; the container further comprising a door integrated within the container;
A climate control system comprising at least one supply and one return defined in the container; a hot and cold distribution unit mounted to the exterior of the container; at least one climate sensor inside the container whereby the sensor signals hot or cold air to enter the container; a dehumidifier processing air within the container; and
A sprinkler system comprising one or more sprinkler heads within the container coupled to a supply line; and a sensor mounted within the container communicates with an output devise to activate or deactivate liquid flow to the supply line and sprinkler head.

2. A safety grow pod of claim 1, further comprising a grey water reclamation system comprising at least two reservoirs; one or more pumps; a control system having one or more sensors; a controller; an output device; a user interface; the sensors are disposed within each of the reservoirs communicating measurements of a liquid to the controller; the controller processes communications from the sensor for controlling the output device; the output device activates one or more of the pumps effectuating the transfer of liquid between the reservoirs via the pump; the user interface receives parameters from an operator and displays output from the controller.

3. A safety grow pod of claim 1, wherein the climate control system further comprises a control system having one or more sensors; a controller; an output device; a user interface; the sensor is disposed within the container communicating measurements to the controller for controlling the output device; the output devise operates the hot and cold air distribution unit.

4. A safety grow pod of claim 1, wherein the sidewall, the top wall, and the base comprise a double-walled insulated panels with a flame spread of less than 25.

5. A safety grow pod of claim 1, wherein the frame has a flame spread of less than 25.

6. A safety grow pod of claim 1, wherein the container further comprises a security system comprising a door having electronic hinges mounted to the frame, an electric lock set integrated within the door; an electric key reader communicates with the electric lock set; hinges and an electronic key.

7. A safety grow pod of claim 1, further comprises a power supply coupled with the electronic components of the system.

8. A safety grow pod of claim 1, further comprising a plant drying system having at least one conveyor with a track and plant mount, the conveyor system is mounted substantially perpendicular the sidewalls and parallel to the top wall wherein pants are mounted to the conveyor system for drying; and a humidifier processing air within the container according to parameters entered into the controller.

9. A method of operating a grow pod water reclamation system
First, receiving liquid in a feeding reservoir;
Second, pumping liquid to one or more plant containers;
Third, collecting liquid waste from the plant containers; and
Fourth, pumping liquid in the collection reservoir to the feeding reservoir.
A method as in claim 9, further comprising
collecting liquid waste from a dehumidifier and an HVAC system into a fresh water reservoir; and
Pumping liquid from the fresh water reservoir to the feeding reservoir.
A method as in claim 9, further comprising
imputing PH and parts per million parameters for the feeding reservoir into a user interface;
transferring data from the user interface to the controller;
receiving data to the controller from sensors in each reservoir regarding PH and parts per million;
actuating one or more pumps in each reservoir based on the relationship between the sensor data and the parameters;
pumping liquid from the collection reservoir to the feeding reservoir;
pumping liquid from the fresh water reservoir to the feeding reservoir; and
de-actuating one or more pumps in each reservoir based on the relationship between the sensor data and the parameters.
